(19) United States
(12) Patent Application Publication
(10) Pub. No.: US 2002/0058183 A1
(43) Pub. Date: May 16, 2002

(54) Sealed battery case

(75) Inventors: Satoru Ono, Aichi-ken (JP); Michihiro Kitayama, Aichi-ken (JP); Mitsuhiro Yoshimura, Aichi-ken (JP); Junji Koizumi, Aichi-ken (JP)

Correspondence Address: PILLSBURY WINTHROP LLP, 1600 TYSONS BOULEVARD, MCLEAN, VA, 22102, US

(73) Assignee: TOYODA GOSEI CO., LTD.

(21) Appl. No.: 09/920,305

(22) Filed: Aug. 2, 2001

(30) Foreign Application Priority Data
Aug. 4, 2000 (JP) 2000-237112

(51) Int. Cl. H01M 2/02; H01M 2/08

(52) U.S. Cl. 429/176; 429/185; 523/134

(57) ABSTRACT

A sealed battery case includes a resin composition comprising 50-100% by weight of a crystalline polypropylene resin having a load deflection temperature (load: 1.81 MPa) of 70° C. or higher and an elongation at tension break (23° C., 50 mm/minute) of 50% or more, and 0-50% by weight of a polyphenylene ether based resin. The resin composition has a weld strength (95° C.) of 13 MPa or more, and a notched bending strength (at 95° C.) of 250 N or more.

### CROSS-REFERENCES TO RELATED APPLICATIONS

The present application claims priority under 35 U.S.C. §119 to Japanese Patent Application No. 2000-237112, filed on Aug. 4, 2000, entitled “SEALED BATTERY CASE”. The contents of this application are incorporated herein by reference in their entirety.

### BACKGROUND OF THE INVENTION

1. Field of the Invention

The present invention relates to a sealed battery case comprising a resin composition.

2. Discussion of the Background

In recent years, sealed secondary battery cases mounted in automobiles or the like are produced from not only metals but also resins.

Among battery cases made of resins, a battery case made of a polypropylene (referred to as “PP” hereinafter)/polyphenylene ether (referred to as “PPE” hereinafter) composite material is mass-produced from the viewpoint of lightness and resistance against chemicals.

About the PP/PPE composite material, a further improvement in strength and heat resistance thereof is necessary in order to increase battery output and make a case small-sized and light.

For this purpose, hitherto, the rigidity, strength, and creep property have been improved during hot working by increasing the PPE content in the PP/PPE composite material.

Many PP/PPE composite materials are suggested in JP-A-2-92957, 9-241499, 10-110069, 6-16924, 3-26740 and 2000-58007 and so on.

JP-A-7-184985 and 8-195188 disclose control of dispersion form of PPE as a manner for improving thermal creep resistance.

PP/PPE composite materials wherein a large amount of PPE is added or the dispersion form of PPE is controlled exhibit improved mechanical properties such as load deflection temperature (i.e., deflection temperature under flexural load) and high-temperature strength. However, when such materials are made up to battery cases and the cases are subjected to a pressure test at high temperature, their corner portions and weld portions are damaged in a short time.

In order to improve pressure resistance at high temperature, which is a particularly important property as endurance performance of sealed battery cases, only an improvement in load deflection temperature, high-temperature strength and creep property thereof is insufficient although the improvement has been conventionally made.

This is based on the following reason. As illustrated in FIG. 1, which will be referred to later, a battery case is in the form of a box composed of a plurality of tanks. Therefore, weld portions or corner portions, which are generated in the step of fashioning the case, become the starting points of stress concentration. Thus, the above-mentioned mechanical properties cannot sufficiently represent the behavior of the weld portions or the corner portions.

Some materials among conventional materials have a large moisture permeability. Therefore, if a battery case made of any one of such materials is used for a long time, the concentration of an electrolyte in the case changes so that the output of the battery decreases or the battery fails.

### SUMMARY OF THE INVENTION

An object of the present invention is to provide a sealed battery case having superior endurance performance at high temperature and a small moisture permeability.

According to one aspect of the invention, a sealed battery case, including: a resin composition including (A) 50-100% by weight of a crystalline polypropylene resin having a load deflection temperature (load: 1.81 MPa) of 70° C. or higher and an elongation at tension break (23° C., 50 mm/minute) of 50% or more and (B) 0-50% by weight of a polyphenylene ether based resin, wherein the resin composition has a weld strength (95° C.) of 13 MPa or more, and a notched bending strength (at 95° C.) of 250 N or more.

The inventors investigated various mechanical properties and found that both the weld strength at high temperature and the notched bending strength (i.e., bending strength of a notched specimen) have an influence on product performance. Thus, the present invention has been made.

Specifically, a sealed battery case including a resin composition having a weld strength (at 95° C.) of 13 MPa or more and a notched bending strength (at 95° C.) of 250 N or more has superior endurance performance and has a low moisture permeability.

In order that a resin composition can exhibit these properties, it is essential that the resin composition has 50% or more by weight of a crystalline PP superior in both heat resistance, that is load deflection temperature at high temperature, and toughness, that is elongation at tension break, and 0-50% by weight of a PPE based resin. Any resin composition in which at least one of its heat resistance and its toughness does not satisfy the above-mentioned requirement cannot produce the advantageous effects of the present invention.

The resin composition includes a crystalline PP having a flexure temperature of 70° C. or higher at a load of 1.81 MPa and an elongation at tension break of 50% or more at a temperature of 23° C. and a tension rate of 50 mm/minute.

By using such a resin composition, the toughness, weld strength and moisture permeation resistance of the crystalline PP as a matrix are improved and further the heat resistance and rigidity of the PPE based resin as domains are improved. Such interaction causes an increase in endurance performance at high temperature and also causes an improvement in the toughness and the pressure resistance, at high temperature, of weld portions and corner portions of a sealed battery case made of the resin composition. As a result, the product performance of the battery case is improved. Therefore, even if the battery case is exposed to high temperature, the mechanical strength thereof is maintained.

Since the moisture permeability of the battery case is lowered, the concentration of an electrolyte in the case does not change even if the case is used for a long time. Thus, it is possible to prevent a drop in the output of the battery and malfunction and/or failure for a long time.

As described above, the present invention can provide a sealed battery case having superior endurance performance at high temperature and a low moisture permeability.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a developed perspective view of a sealed battery case with a lid in Embodiment 1, as is viewed from its side wall.

FIG. 2 is a partially-cutaway perspective view of the sealed battery case in Embodiment 1.

FIG. 3 is a perspective view of the sealed battery case, in Embodiment 1 as is viewed from its bottom side.

FIG. 4 is an explanatory view illustrating a method of measuring notched bending strength in Embodiment 1.

FIG. 5 is an explanatory view of a hot pressure test in Embodiment 1.

FIG. 6 is a graph showing a relationship between the bending displacement of the resin composition of sample 2 and bending load in Embodiment 1.

FIG. 7 is a graph showing a relationship between the bending displacement of the resin composition of comparative sample C1 and bending load in Embodiment 1.

FIG. 8 is an explanatory view showing a relationship between weld strength and notched bending strength.

FIG. 9 is a partially-cutaway perspective view of a sealed battery case for purpose of illustrating a broken site.

FIG. 10 is a perspective view of the sealed battery case for purpose of illustrating the broken site, as is viewed from its bottom side.

### DESCRIPTION OF THE PREFERRED EMBODIMENTS

The crystalline PP contained in the resin composition of the present invention has a load deflection temperature of 70° C. or higher. If this temperature is below 70° C., the heat resistance drops. Thus, if the battery case made of such a resin is actually used, the case may deform, or break.

It is preferable that the upper limit of the load deflection temperature is 150° C. since a drop in mechanical properties, such as elongation at tension break, is prevented.

The load deflection temperature is more preferably 75° C. or higher.

The elongation at tension break of the crystalline PP is 50% or more. If the elongation is below 50%, the toughness drops so that the battery case may break even by a small deformation thereof.

It is preferable that the upper limit of the elongation at tension break is 500% or lower since a drop in the thermal deformation temperature or bend elastic rate is prevented.

It is preferable that in the case that the crystalline PP used is defined by its molecular weight, the PP having a weight average molecular weight, which is the weight average molecular weight being obtained by a high-temperature GPC method, is 250000 or more.

In this case, the elongation at break of the crystalline PP can be made to 50-500%.

The weight average molecular weight is more preferably 280000 or more.

The high-temperature GPC method, that is, the method of measuring the distribution of the molecular weight in terms of polystyrene is performed under the following conditions.

Device: Waters 150C type high-temperature GPC device,

Column: GMH HR-H(S)HT (product of type manufactured by Tosoh Co., Ltd) 7.8 mm x 300 mm (the number thereof: 2),

Transfer phase solvent: o-dichlorobenzene (0.1% BHT added) 140° C., 1 mL/minute,

Sample: 500 μL of 0.1% o-dichlorobenzene solution is poured therein,

Detector: differential refractometer, and

Standard: monodispersive standard polystyrene (product of type manufactured by Tosoh Co., Ltd) 1000-2880000

It is preferable that in the case that the crystalline PP is defined by its melt flow rate (MFR), the PP has a MFR of 5.0 g/10 minutes or less. In this case, good formability (moldability) can be obtained.

The MFR is more preferably 0.2-5.0 g/10 minutes.

The resin composition related to the present invention comprises the crystalline PP and a PPE based resin. The crystalline PP content is 50-100% by weight. If the crystalline PP content is below 50% by weight, a drop in the toughness, the weld strength, the moisture permeability of the battery case may occur.

If the weld strength of the resin composition related to the present invention is below 13 MPa, break may be caused from the weld portions.

The weld strength gets larger as the molecular weight of the crystalline PP becomes larger. The upper limit of the weld strength is preferably 50 MPa or less since the elongation at tension break and the MFR of the crystalline PP need to be within the given ranges.

The weld strength is more preferably 14 MPa or more.

If the notched bending strength of the resin composition is below 250 N, break may be caused from the corner portions.

The upper limit of the notched bending strength is preferably 1000 N or less since the weld strength is lowered with a rise in the bending strength.

The crystalline PP used in the present invention will be specifically described.

The crystalline PP is a crystalline polypropylene resin which is a homopolymer or a copolymer. This resin is a crystalline resin obtained by polymerization of propylene as a main component. Specific examples thereof include a homopolymer of propylene, and copolymers obtained by copolymerization of propylene as a main component and a-olefin such as ethylene, butene-1, hexane-1, heptene-1, or 4-methylpentene-1.

About the crystalline PP, the copolymer may be a random copolymer or a block copolymer, and is preferably a block copolymer wherein a propylene-α-olefin copolymer is dispersed in a polypropylene polymer. It is preferable that examples of the crystalline polypropylene resin which is a homopolymer or a copolymer include a propylene homopolymer, and propylene-ethylene block copolymers.

Examples of the method for producing the crystalline polypropylene resin which is a homopolymer or a copolymer include a method of yielding polypropylene having a density within the above-mentioned range by polymerization, and a method of yielding polypropylene having a density within the above-mentioned range by adding a nucleating agent to polypropylene having a lower density and thus improving the density.

The nucleating agent may be any one making it possible to improve the crystallinity of polypropylene.

Typical examples thereof include organic nucleating agents such as metal salts of aromatic carbonic acids, sorbitol derivatives, salts of organic phosphoric acid, and aromatic amide compounds; and inorganic nucleating agents such as talc. However, the nucleating agent used in the present invention is not limited to these examples.

The PPE based resin used in the present invention will be specifically described.

Examples of the PPE based resin include polyphenylene ether, and a mixture of polyphenylene ether and a styrene-based resin.

The polyphenylene ether may be a homopolymer or a copolymer having a structure represented by the following general formula:

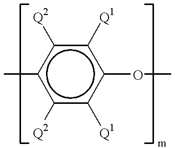

In the formula, Q¹'s each independently represents a halogen atom, a primary or secondary alkyl, aryl, aminoalkyl, oxyhydrocarbon or halo oxyhydrocarbon radical; Q²'s each independently represents a hydrogen or halogen atom, a primary or secondary alkyl, aryl, haloalkyl, oxyhydrocarbon or halo oxyhydrocarbon radical; and m is a number of 10 or more.

Preferred examples of the primary alkyl radical as Q¹ or Q² include methyl, ethyl, n-propyl, n-butyl, n-amyl, isoamyl, 2-methylbutyl, n-hexyl, 2,3-dimethylbutyl, 2-, 3-, or 4-methylpentyl, or heptyl. Preferred examples of the secondary alkyl radical include isopropyl, sec-butyl or 1-ethylpropyl. In many cases, Q¹ is an alkyl or phenyl radical and is particularly an alkyl radical having 1-4 carbon atoms, and Q² is a hydrogen atom.

The homopolymer of the polyphenylene ether is preferably a polymer composed of a 2,6-dimethyl-1,4-phenylene ether unit. The copolymer thereof may be a random copolymer composed of combinations of this unit and a 2,3,6-trimethyl-1,4-phenylene ether unit. Many preferred homopolymers and random copolymers are described in patent publications and literatures. For example, a polyphenylene ether including a molecule-constituting moiety for improving properties such as a molecular weight, melting viscosity and/or impact strength is also preferable.

The intrinsic viscosity of the polyphenylene ether is preferably 0.2-0.8 dl/g, more preferably 0.2-0.7 dl/g, and most preferably 0.25-0.6 dl/g in measurement at 30° C. in chloroform. If the intrinsic viscosity is below 0.2 dl/g, the impact resistance of the resin composition is insufficient. If the intrinsic viscosity is over 0.8 dl/g, the formability thereof is insufficient.

Examples of the styrene-based resin include polystyrene and rubber-reinforced polystyrene. The blend ratio of the styrene-based resin is preferably 0-80% by weight of the total of the polyphenylene ether and the styrene-based resin. If the blend ratio is over 80% by weight, the heat resistance of the resin composition drops easily.

To the sealed battery case of the present invention, an agent for compatibility, an antioxidant, a nucleation accelerator, a coloring agent or the like may be added.

When the sealed battery case is produced, the crystalline PP and the PPE based resin are kneaded in any one of various kneaders to make pellets. The pellets are formed into a desired shape by, for example, injection molding or extrusion molding.

It is preferable that in the resin composition, the crystalline polypropylene resin content is from 50 to 99.9% by weight and the polyphenylene ether based resin content is from 0.1 to 50% by weight.

By mixing the crystalline PP and the PPE based resin at a ratio within the above-mentioned range, the notched bending strength of the battery case is further improved.

The crystalline PP content and the PPE based content in the resin composition are more preferably 55-99% by weight and 5-45% by weight, respectively. In this way, the notched bending strength can be made still higher.

In the case that a battery case whose pressure resistance is particularly important is needed, it is preferable to use a resin composition including both of the crystalline PP and the PPE based resin.

In the case that a battery case whose moisture permeation resistance is particularly important is needed, it is preferable to reduce the amount of the added PPE based resin as much as possible.

It is preferred that in the resin composition, the crystalline polypropylene resin content is 100% by weight and the polyphenylene ether based resin content is 0% by weight.

In this case, the moisture permeation resistance of the battery case can be made better.

Embodiment 1

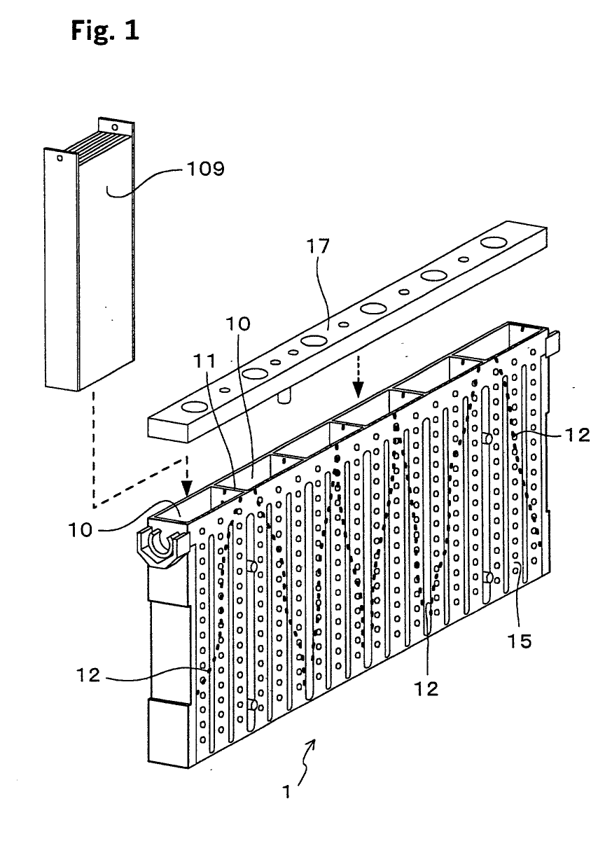

The sealed battery case according to the present invention will be described referring to FIGS. 1-5.

A sealed battery case 1 of Embodiment 1 is a case obtained by subjecting a resin composition including the crystalline PP and the PPE based resin to injection molding.

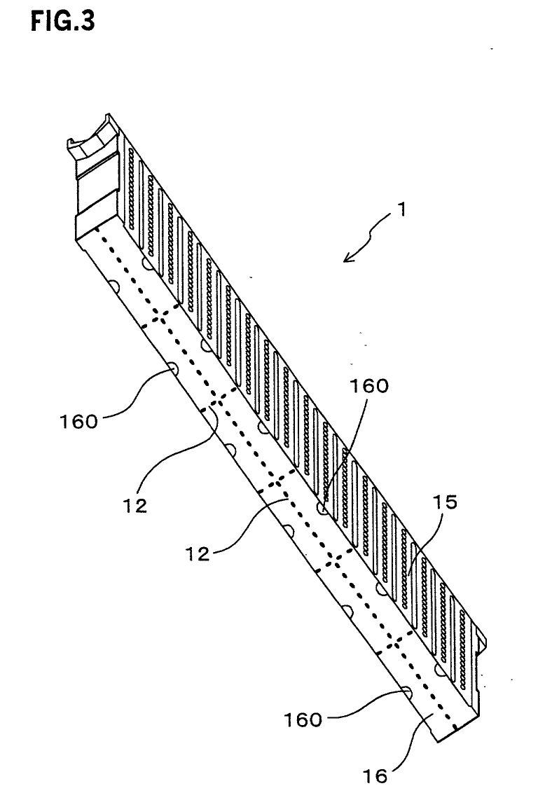

As illustrated in FIGS. 1-3, the sealed battery case 1 is divided into a plurality of tanks 10 by partitions 11. Electrodes 109 are fitted in the respective tanks 10. The tanks 10 are filled with electrolyte. A lid 17 is welded to the sealed battery case 1. As illustrated in FIG. 3, gates 160 for injection-molding the sealed battery case 1 are made at a plurality of positions in a bottom wall 16.

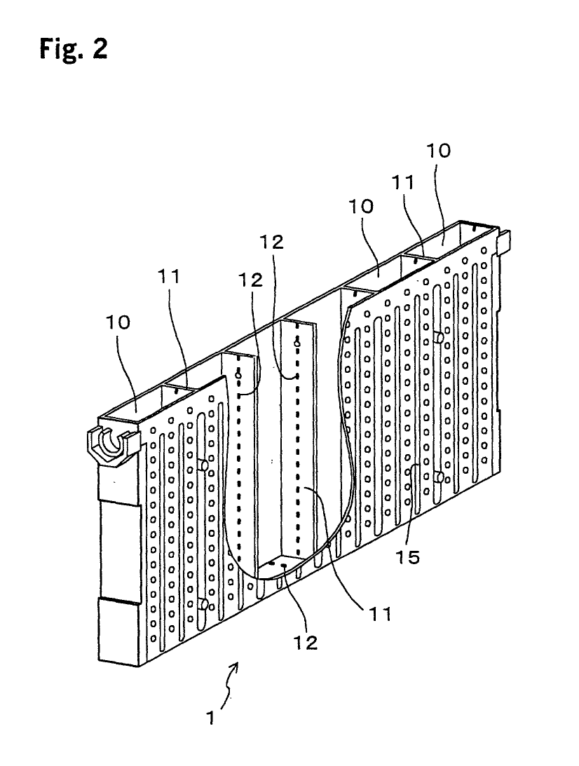

At the time of the molding, weld lines 12 may be formed in material-fused portions of a side wall 15 (FIG. 1), partitions 11 (FIG. 2), and the bottom wall 16 (FIG. 3).

The resin composition used in the sealed battery case 1 is a resin composition including the crystalline PP and the PPE based resin.

For this resin composition, samples 1-5 and comparative samples C1-C3 shown in Table 1 were prepared. The following investigation was made.

First, the respective samples and comparative samples will be described.

As the crystalline PPs, three kinds, that is, sample 6 and comparative samples C4 and C5 according to Embodiment 2 which will be described later were prepared. Physical properties and weight average molecular weights of the three kinds of the crystalline PPs are described in Table 2 about Embodiment 2, which will be described later.

A PPE based resin was blended with each of the crystalline PPs. The blend composition of each crystalline PP and the PPE based resin is shown in Table 1.

The respective resin compositions were used as samples 1-5, and comparative samples C1-C3.

To each of the resin compositions, a SEPS (a styrene-ethylene-propylene-styrene copolymer) as an agent for compatibility was added in an amount of 10% of the PPE based resin.

Respective physical properties for characterizing the respective samples and the respective comparative samples were measured according to the following manners.

(Weld Strength)

In order to measure weld strength, each of the resins was poured into an ASTM (D638) No. 1 dumbbell from upper and lower sites thereof. Thus, a test piece having, at its center, a weld portion was molded. This test piece was subjected to a tension test in accordance with ASTM D638. In the test, the temperature was 95° C., and the tension rate was 10 mm/minute.

(Notched Bending Strength)

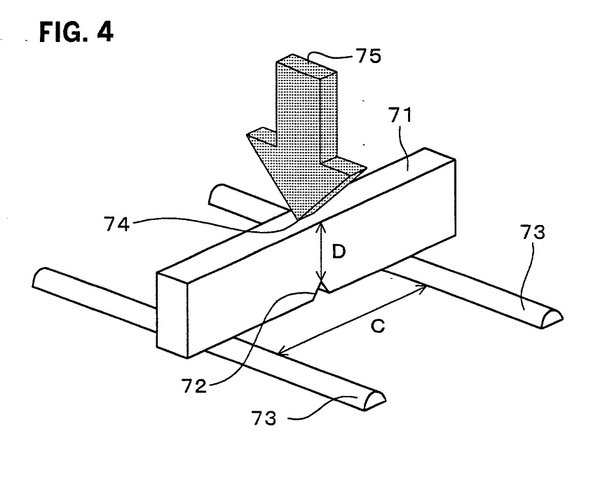

The situation of this test is illustrated in FIG. 4.

A bending test piece 71 according to ASTM D790 was subjected to a notch-making process and then a bending test of the notched test piece was performed in accordance with D790.

The notch-making process was performed on the basis of the notch-making process in an Izod impact test according to ASTM D256. The distance D between a notch 72 and a pressing point 74 was 10 mm.

In FIG. 4, the distance C between supporting bases 73 was set to be 40 mm. The notch 72 was directed to a floor face. A pressure power 75 was applied to the notch 72 from the just above, and the sample piece 71 was bent at a rate of 2 mm/minute. The temperature upon the test was set to be 95° C.

In this test, a relationship between the displacement by bending (that is, bending deflection) and the load when the deflection was generated was measured.

The bending load when the bending deflection was 10 mm was defined as notched bending strength.

(Load Deflection Temperature)

Load deflection temperature was measured in accordance with ASTM D648. The pressing power when a load was applied was set to be 1.81 MPa.

(Elongation at Tension Break)

Elongation at tension break was measured in accordance with ASTM D638. Upon the tension test, the temperature was 23° C., and the tension rate was 10 mm/minute.

(Hot Pressure Resistance)

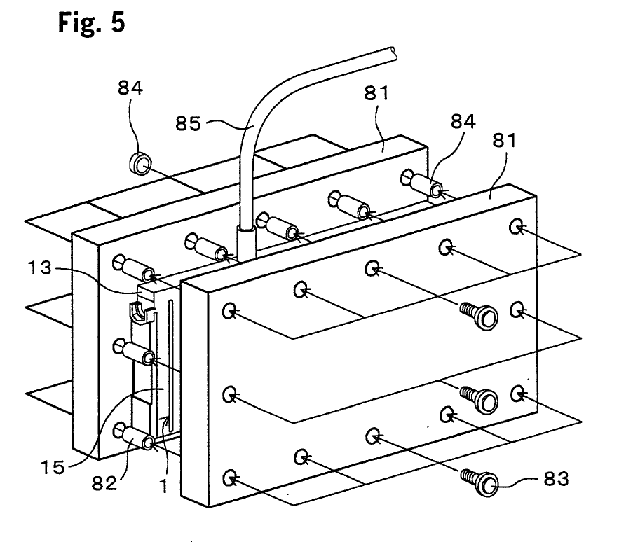

As illustrated in FIG. 5, in an atmosphere having a temperature of 95° C., the sealed battery case 1 composed of each of samples 1-5 and comparative samples C1-C3 was sandwiched, from its two side walls 15, by two plate-form fixtures 81 having a thickness sufficient not to be deformed in the present test. Thickness-adjusting members 82 were interposed between the plate-form fixtures 81 and then the fixtures 81 were fastened with bolts 83 and nuts 84.

In this way, each of the side walls 15 of the sealed battery case 1 was restrained in the state that the wall 15 was compressed by 0.1 mm. At this time, faces other than the side walls of the sealed battery case 1 were not restrained. A hose 85 was attached to the welded lid 13. Air was compressed into the inside of the case. The pressing power by the air was set to be 1 MPa.

The battery case 1 was divided into a plurality of tanks, but the respective tanks constituted a continuous space since a hole was made in one position of each of the partitions. Thus, the pressure by the air was applied to the respective tanks. In this state, the pressure by the air was continuously applied. The time until the battery case 1 was broken was measured.

The hot pressure resistance is an index representing whether the endurance (pressure resistance) at high temperature of the battery case 1 is good or bad when the sealed battery case 1 illustrated in FIGS. 1-3 is produced.

(Water Permeability)

Water permeability was measured in accordance with B method in JIS K7129. Upon the test, the temperature was set to be 40° C., the humidity was set to be 90% RH and the thickness of a test piece is set to be 2 mm. From this test, the permeation amount of water could be obtained per unit area and unit time.

Since water does not permeate easily through a material having a low moisture permeability, the material is superior in moisture permeation resistance.

The moisture permeability is an index representing whether or not the concentration of the electrolyte changes easily when the battery is used for a long time.

Results of the above-mentioned measurements are shown in Table 1.

Samples 1-5 were resin compositions including (A) 55-99% by weight of a crystalline PP having a load deflection temperature of 70° C. or higher and an elongation at tension break of 50% or more, and (B) 1-45% by weight of a PPE based resin.

The crystalline PPs used in comparative samples C1-C3 were not crystalline PPs having a load deflection temperature of 70° C. or higher and an elongation at tension break of 50% or more.

As is known form Table 1, all of samples 1-5 had higher weld strength, notched bending strength and hot pressure resistance than comparative samples C1-C3, and had a moisture permeability not more than comparative samples C1-C3 so that samples 1-5 were superior in moisture permeation resistance.

TABLE 1
PP/PPE Composite Material

| | | | | | | Comparative | Comparative | Comparative |
|---|---|---|---|---|---|---|---|---|
| | Sample 1 | Sample 2 | Sample 3 | Sample 4 | Sample 5 | Sample C1 | Sample C2 | Sample C3 |
| composition | | | | | | | | |
| Sample 6 (5 by weight) | 55 | 65 | 85 | 95 | 99 | | | |
| Comparative sample C4 | | | | | | | | 55 |
| (% by weight) | | | | | | | | |
| Comparative sample C5 | | | | | | 50 | 65 | |
| (% by weight) | | | | | | | | |
| PPE (% by weight) | 45 | 35 | 15 | 5 | 1 | 50 | 35 | 45 |
| Weld strength* (Mpa) | 14.8 | 16.4 | 15.6 | 15.7 | 15.7 | 12.6 | 12.4 | 14.6 |
| Notched bending strength* (N) | 340 | 350 | 320 | 310 | 310 | 110 | 430 | 200 |
| Load deflection temperature (° C.) | 105 | 101 | 86 | 86 | 85 | 100 | 80 | 106 |
| Elongation at tension break (%) | 200 | 280 | 490 | 370 | 250 | 180 | 340 | 180 |
| Hot pressure resistance (minute) | 150 | 105 | 420 | 250 | 200 | 40 | 70 | 45 |
| Water permeability (g/m² 24 hours) | 0.39 | 0.38 | 0.20 | 0.18 | 0.18 | 0.43 | 0.41 | 0.39 |

*: measured at the temperature of 95° C.

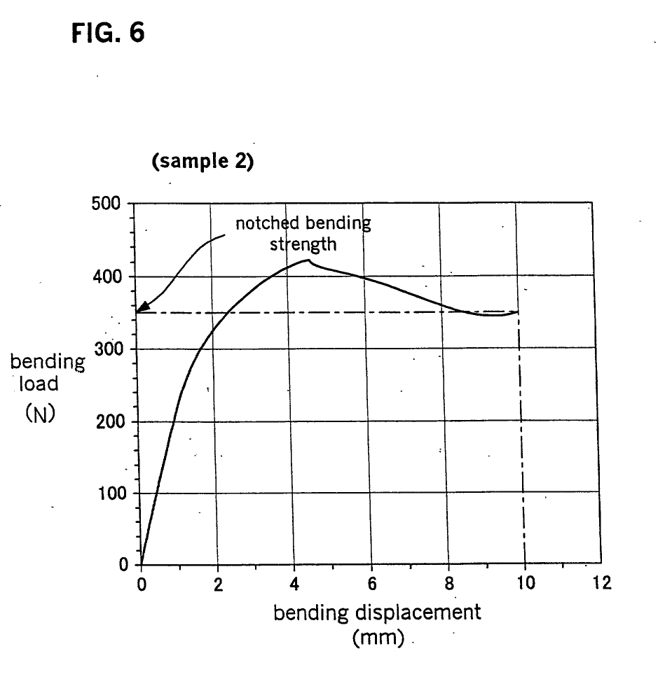

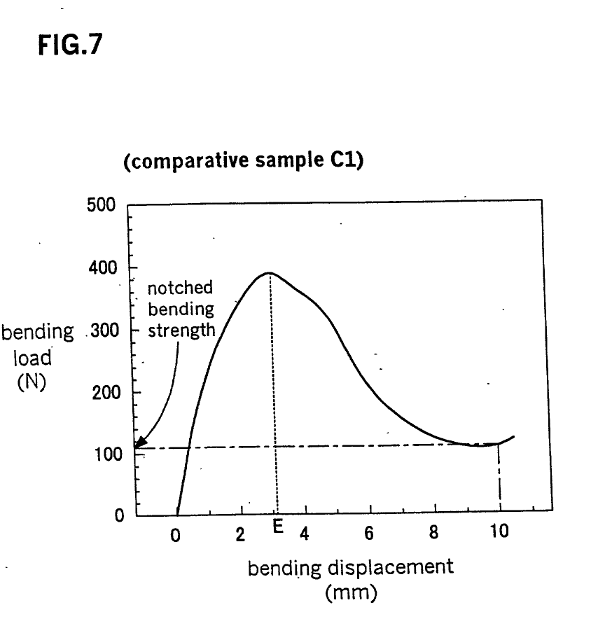

Concerning sample 2 and comparative sample C1, relationships between bending load and bending deflection at the time of measuring the notched bending strength thereof are shown in FIGS. 6 and 7.

As shown in FIG. 7, in the case of comparative sample C1, the bending load increased as the bending deflection increased. However, when the bending deflection exceeded a deflection E, a crack was developed from the notch portion so that the test sample was broken off. Therefore, the bending load decreased suddenly.

On the other hand, as shown in FIG. 6, in the case of sample 2, the bending deflection exceeded the deflection E, which was the maximum point in the case of comparative sample C1, and a very small crack was generated in the notch portion. Thereafter, the crack was not largely developed. The degree of the decrease in the bending load was also small.

About the other samples and comparative samples, similar results were obtained.

Embodiment 2

In the present embodiment, resin compositions made of crystalline PP were subjected to the same measurements as in Embodiment 1.

As the crystalline PPs, samples 6, 7 and 8 and comparative samples C4, C5 and C6 having weight average molecular weights and melt flow rates shown in Table 2 were prepared.

These crystalline PPs were subjected to the same tests as in Embodiment 1.

However, the tension rate in the test of the elongation at tension break was set to be 50 mm/minute.

Results of the above-mentioned measurements are shown in Table 2.

Each of samples 6-8 was made of (A) a crystalline PP having a load deflection temperature of 70° C. or higher and an elongation at tension break of 50% or more. Each of comparative samples C4-C6 was made of a crystalline PP, which did not satisfy the above-mentioned requirement.

As is known from Table 2, all of samples 6-8 had higher weld strength, notched bending strength and hot pressure resistance than comparative samples C4-C6, and had a lower moisture permeability than comparative samples C4-C6 so that samples 6-8 were superior in moisture permeation resistance.

TABLE 2
PP

| | | | | Comparative | Comparative | Comparative |
|---|---|---|---|---|---|---|
| | Sample 6 | Sample 7 | Sample 8 | Sample C4 | Sample C5 | Sample C6 |
| Weld Strength* (Mpa) | 15.8 | 16.1 | 14.7 | 15.2 | 10.5 | 16.0 |
| Notched bending strength* (N) | 310 | 290 | 280 | 120 | 140 | 180 |
| Melt flow rate (g/10 minutes) | 2.3 | 1.5 | 0.5 | 18 | 6 | 8 |
| Weight average molecular weight | 331000 | 378000 | 398000 | 160000 | 238000 | 210000 |
| Load deflection temperature (° C.) | 85 | 89 | 75 | 83 | 66 | 88 |
| Elongation at tension break (%) | 200 | 60 | 90 | 40 | 150 | 20 |
| Hot pressure resistance (minute) | 180 | 100 | 80 | 50 | 35 | 20 |
| Water permeability (g/m² · 24 hours) | 0.17 | 0.16 | 0.18 | 0.17 | 0.19 | 0.16 |

*measured at the temperature of 95° C.

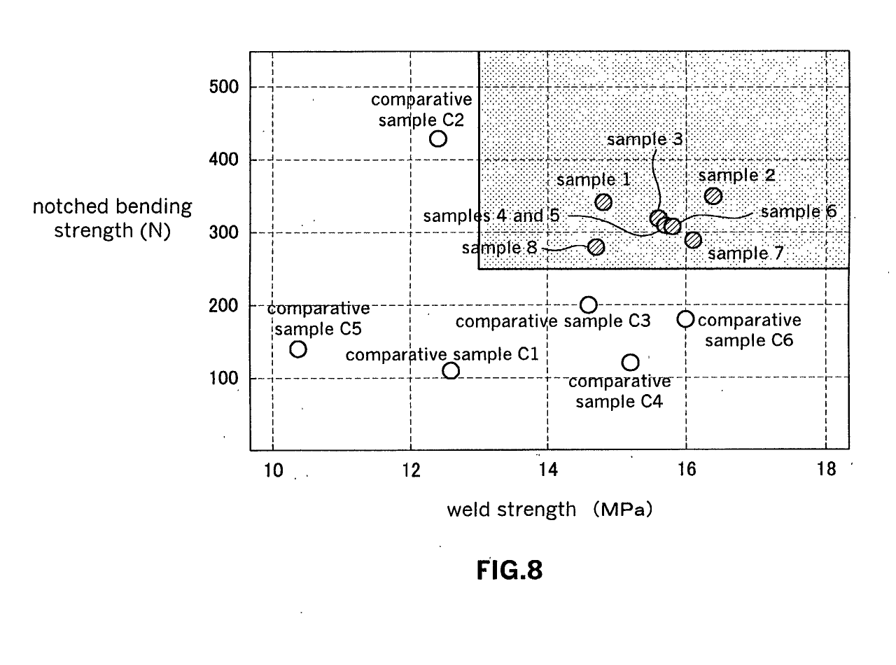

On the basis of Embodiment 1 and the above description, a relationship between weld strength and notched bending strength of samples 1-8 and comparative samples C1-C6 are shown in FIG. 8.

As shown in FIG. 8, all of samples 1-8 had a weld strength of 13 MPa or more and a notched bending strength of 250 N or more.

Even if a pressing power of 1 MPa at a high temperature of 95° C. was applied to sealed battery cases molded from these resin compositions, no break was caused.

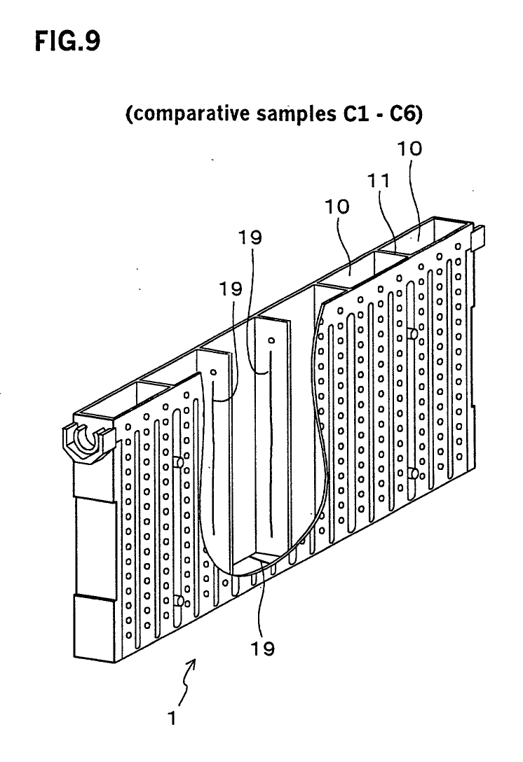

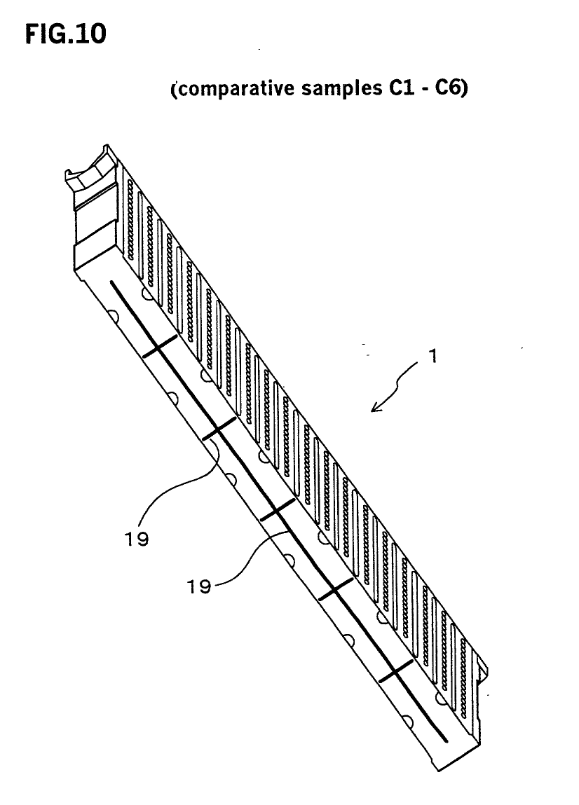

In the sealed battery cases molded from comparative samples C1-C6, break lines 19 were generated in their weld lines as illustrated in FIGS. 9 and 10.

It can be understood from this fact that battery cases molded by using a crystalline PP having a weld strength of 13 MPa or more and a notched bending strength of 250 N or more are superior in pressure resistance at high temperature.

In the battery cases molded from samples 1-8, their resin compositions are superior in moisture permeation resistance. Therefore, their electrolyte does not volatilize easily.

For this reason, even if they are used for a long time, the concentration of the electrolyte is kept constant so that a drop in the output of the batteries and malfunction and/or failure does not easily occur. Thus, the endurance thereof can be made long.

Samples 3-5 had better hot pressure resistance and larger moisture permeability than samples 6-8. It can be understood from this that battery cases made of a PP/PPE composite material have higher hot pressure resistance and somewhat poorer moisture permeation resistance than battery cases made only of PP.

Therefore, in the case that a battery, which is excellent in endurance and pressure resistance, is needed, a battery case made of crystalline PP and a PPE based resin should be used. In the case that a battery having superior moisture permeation resistance, containing an electrolyte whose concentration does not change by use for a long time, and having a superior performance that does not deteriorate easily is needed, a battery case made only of PP should be used.

Obviously, numerous modifications and variations of the present invention are possible in light of the above teachings. It is therefore to be understood that, within the scope of the appended claims, the invention may be practiced otherwise than as specifically described here.

Waht is claimed is:

1. A sealed battery case, comprising:
a resin composition including,
(A) 50-100% by weight of a crystalline polypropylene resin having a load deflection temperature of 70° C. or higher at a load of 1.81 Mpa and an elongation at tension break of 50% or more at 23° C. and 50 mm/minute elongation, and
(B) 0-50% by weight of a polyphenylene ether based resin,
wherein the resin composition has a weld strength of 13 MPa or more at 95° C., and a notched bending strength of 250 N or more at 95° C.

2. The sealed battery case according to claim 1, wherein the crystalline polypropylene resin content is from 50 to 99.9% by weight and the polyphenylene ether based resin content is from 0.1 to 50% by weight.

3. The sealed battery case according to claim 1, wherein the crystalline polypropylene resin content is 100% by weight and the polyphenylene ether based resin content is 0% by weight.

4. The sealed battery case according to claim 1, wherein the elongationat tension break of the crystalline polypropylene resin is 500% or lower.

5. The sealed battery case according to claim 4, wherein the crystalline polypropylene resin contact is from 50 to 99.9% by weight and the polyphenylene ether based resin content is from 0.1 to 50% by weight.

6. The sealed battery case according to claim 4, wherein the crystalline polypropylene resin content is 100% by weight and the polyphenylene ether based resin content is 0% by weight.

7. The sealed battery case according to claim 1, wherein the weld strength of the resin composition is 50 Mpa or less.

8. The sealed battery case according to claim 7, wherein the crystalline polypropylene resin content is from 50 to 99.9% by weight and the polyphenylene ether based resin content is from 0.1 to 50% by weight.

9. The sealed battery case according to claim 7, wherein the crystalline polypropylene resin content is 100% by weight and the polyphenylene ether based resin content is 0% by weight.

10. The sealed battery case according to claim 1, wherein the notched bending strength of the resin composition is 100 N or less.

11. The sealed battery case according to claim 10, wherein the crystalline polypropylene resin content is from 50 to 99.9% by weight and the polyphenylene ether based resin content is from 0.1 to 50% by weight.

12. The sealed battery case according to claim 10, wherein the crystalline polypropylene resin content is 100% by weight and the polyphenylene ether based resin content is 0% by weight.
